(19) United States
(12) Patent Application Publication
(10) Pub. No.: US 2016/0125348 A1
(43) Pub. Date: May 5, 2016

(54) Motion Tracking Wearable Element and System

(71) Applicant: Motion Insight LLC, Austin, TX (US)

(72) Inventors: Don Dyer, Austin, TX (US); Travis Dyer, Austin, TX (US); Rex Gore, Austin, TX (US)

(73) Assignee: Motion Insight LLC, Austin, TX (US)

(21) Appl. No.: 14/930,342

(22) Filed: Nov. 2, 2015

Related U.S. Application Data
(60) Provisional application No. 62/074,528, filed on Nov. 3, 2014.

(51) Int. Cl. G06Q 10/06; H04W 4/04; H04B 5/00

(52) U.S. Cl. CPC G06Q 10/06398; H04B 5/0062; H04W 4/04

(57) ABSTRACT

In certain embodiments, a system may include a wearable element having a rechargeable battery, at least one sensor circuit configured to capture movement data, and a transceiver configured to communicate the movement data. The system may further include a base unit including a docking component configured to recharge the rechargeable battery and configured to communicate with the transceiver to receive at least one of the movement data and an action determined from the movement data.

### CROSS-REFERENCE TO RELATED APPLICATION(S)

This application is a non-provisional of and claims priority to U.S. Provisional Patent Application No. 62/074,528 filed on Nov. 3, 2014 and entitled “Motion Tracking Wearable Element,” which is incorporated herein by reference in its entirety.

### FIELD

The present disclosure is generally related to activity tracking and productivity analysis, and more particularly to system(s) and method(s) to provide employee motion tracking.

### BACKGROUND

An organization may employ various types of systems, such as time management systems, docketing systems, personnel management systems, accounting systems, other systems, or any combination thereof, to maintain and track resources within the organization. Within service industries, such as janitorial services, maintenance service, construction, retail sales, security, or other service industries, it can be difficult to track and assess performance of their most important resources, namely their employees.

### SUMMARY

In certain embodiments, a system may include a wearable element having a rechargeable battery, at least one sensor circuit configured to capture movement data, and a transceiver configured to communicate the movement data. The system may further include a base unit including a docking component configured to recharge the rechargeable battery and configured to communicate with the transceiver to receive at least one of the movement data and an action determined from the movement data. In certain embodiments, the data may be processed to determine an activity intensity of a worker.

In other certain embodiments, a system may include a wearable badge configured to record sensor data and a computing device configured to receive the sensor data. The computing device may include a signal processing circuit configured to translate the sensor data into metrics, an action classifier configured to transform the metrics to discrete movements, and an activity estimator to determine one or more tasks based on the discrete movements.

In still other certain embodiments, a method may include receiving motion data from one or more inertial measurement units of a wearable element at a computing device and determining, using a signal processor of the computing device, metrics based on the motion data. The method may further include transforming the metrics into discrete movements using an action classifier of the computing device and determining one or more tasks based on the discrete movements using an activity estimator of the computing device. The method may also include selectively sending an alert to a destination device using at least one of a reporting module and a productivity analysis module of the computing device based on the one or more tasks.

### BRIEF DESCRIPTION OF THE DRAWINGS

FIG. 1 depicts a block diagram of a system to provide motion tracking that can include a movement tracking wearable element, in accordance with certain embodiments of the present disclosure.

FIG. 2 depicts a block diagram of a system to provide motion tracking that can include a movement tracking wearable element, in accordance with certain embodiments of the present disclosure.

FIG. 3 depicts a block diagram of a system to provide motion tracking, in accordance with certain embodiments of the present disclosure.

FIG. 4 depicts a block diagram of a system configured to provide motion tracking, in accordance with certain embodiments of the present disclosure.

FIG. 5 depicts a perspective view of a front portion of a movement tracking wearable element, in accordance with certain embodiments of the present disclosure.

FIG. 6 depicts a diagram of a circuit within a movement tracking wearable element to provide motion tracking, in accordance with certain embodiments of the present disclosure.

FIG. 7 depicts a perspective view of a rear portion of a movement tracking wearable element, according to certain embodiments.

FIGS. 8A and 8B depict graphs of voltage versus time for a magnetometer signal indicating slight turning of the body left or right and returning to forward facing every second, in accordance with certain embodiments of the present disclosure.

FIGS. 9A and 9B depict graphs of voltage versus time for an accelerometer reading indicating a back-and-forth movement in the “forward facing” axis occurring every second and a back-and-forth movement in the “up/down” axis occurring every few seconds, in accordance with certain embodiments of the present disclosure.

FIG. 10 depicts a graph of voltage versus time for two locator units, in accordance with certain embodiments of the present disclosure.

FIG. 11 depicts a diagram of a table showing employee activity intensity, in accordance with certain embodiments of the present disclosure.

FIG. 12 depicts a flow diagram of a method of determining motion signature corresponding to a physical action (or set of actions), in accordance with certain embodiments of the present disclosure.

FIG. 13 depicts a flow diagram of a method of determining actions based on movement data and stored signatures, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

This disclosure generally relates to technology that allows movement data to be tracked and reported. As used herein, “movement data” and “motion data” may include movement, motion, location, or orientation data, or any combination thereof. In certain embodiments, motion data may be analyzed to determine particular movements and may be correlated in time and space to determine whether or not specific physical activities were completed. While such technology can be applicable to any type of movement or activity, specific examples are given herein that discuss using such technology to allow an employer to track activities of an employee, such as a custodial employee tasked with performing particular cleaning activities, maintenance activities, or both.

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. In some embodiments, features of the various embodiments and examples herein can be combined, exchanged, or removed without departing from the scope of the present disclosure.

In accordance with various embodiments, the methods and functions described herein may be implemented with electronic devices, at least one of which may be a wearable device that can be attached to the clothing of a person. In some embodiments, the wearable device may be implemented as a smart badge or employee identification card that includes computing elements and optionally a radio frequency identifier (RFID) circuit configured to communicate with a card reader to determine access to restricted areas of a building. In some embodiments, the wearable device may be implemented as a watch, a pin, or another item or article of clothing or accessory designed to be worn by a person.

In some embodiments, at least some of the functionality may be implemented as one or more software programs running on a processor or controller, which may be within the employee badge, included within a base station configured to recharge and communicate with the employee badge, included within a computing system communicatively coupled to the base station to the employee badge, or any combination thereof. In accordance with various embodiments, the computing device may be a tablet computer, a smartphone, a personal computer, a server, another data processing device, or any combination thereof. Dedicated hardware implementations (such as the wearable badge, a base station, or another electronic hardware device) including, but not limited to, application specific integrated circuits, programmable logic arrays, and other hardware devices can likewise be constructed to implement the methods and functions described herein. Further, in certain embodiments, at least some of the methods described herein may be implemented as a device, such as a computer readable storage device or memory device, including instructions that when executed cause a processor to perform the methods. In certain embodiments, the computer readable storage device or memory device may include an optical disk, a hard disc drive, a flash memory device, a read-only memory (ROM) device, a cache memory device, another physical memory apparatus, or any combination thereof.

In certain embodiments, a system may include one or more wearable structures, such as a badge, a watch, a phone, a wrist band, a head band, another device, or any combination thereof, which may be configured to collect and communicate movement data to a management system. In certain embodiments, the one or more wearable structures may include a transceiver configured to communicate the collected data to a receiving device, which may be a recharge station (e.g., a base unit), a computing device, a server, a networked data storage device, another device, or any combination thereof. In certain embodiments, the transceiver may communicate via a wireless communication link, such as a short-range wireless signal (e.g., Bluetooth®), a local area wireless network signal (e.g., IEEE 802.11x), a cellular, digital or satellite signal, or any combination thereof. In certain embodiments, the transceiver may communicate via a wired connection, an inductive link, optically, or through another physical or wireless communication link.

The recharge device (or base unit) may include one or more slots to receive a corresponding number of wearable devices, or optionally a transceiver configured to communicate with transceivers of the wearable devices. In some embodiments, the recharge device may include data processing circuitry configured to process raw data from the wearable devices into different formats or to process the raw data to determine actions or tasks based on the movement data. In certain embodiments, the recharge device may be configured to communicate data to a management system, which may be a computing device. Further, in certain embodiments, the recharge device may be configured to recharge the wearable devices inductively.

The management system may be configured to receive and analyze the data for purposes of recognizing, rewarding, or coaching performance. In certain embodiments, the management system may be utilized to track attendance, perform time-keeping, analyze activity to determine movements, analyze activity to identify work practices or habits, monitor work practices, generate reports, and so on. In certain embodiments, the management system may produce data that can be used for various purposes including, for example, determining if, where, when, and how certain activities are being performed and whether the performance of such activities is safe or unsafe (based on the movement data). Further, in certain embodiments, such information can be used to determine if a particular employee was in an unauthorized location. In certain embodiments, a location of the employee badge when an activity is performed may be determined based on a relative signal strength of two or more RF signals captured by a receiver of the employee badge using triangulation. In some embodiments, the wearable element may be calibrated to determine where the access points in space and then to estimate the location of the wearable element based on the relative signal strength readings. Other embodiments are also possible.

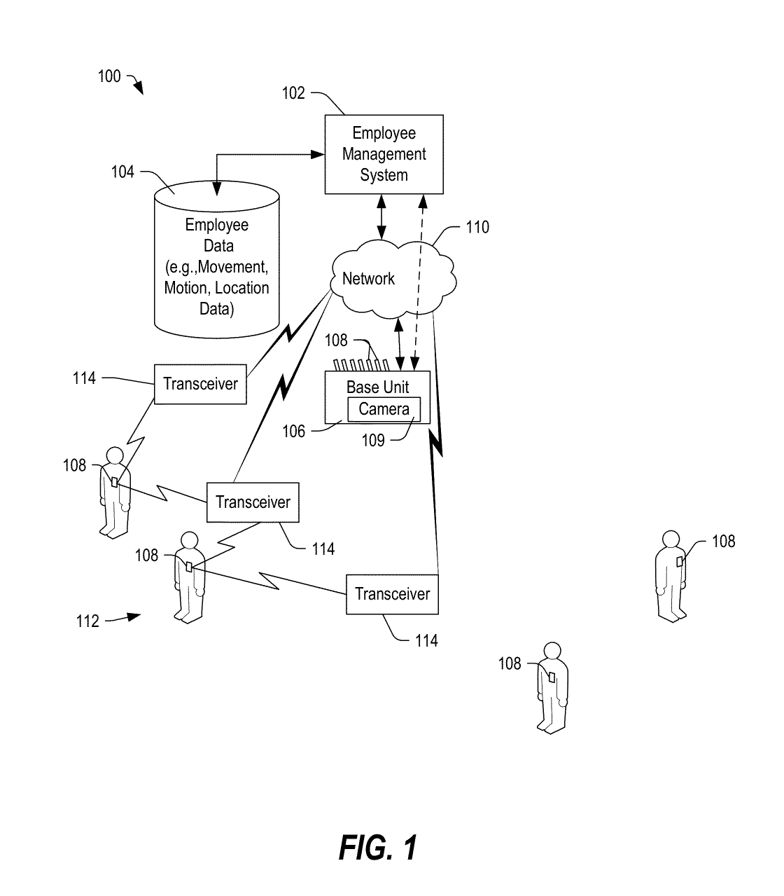

Embodiments of a system including a wearable element configured to track motion may be provided in a variety of configurations and forms. One possible embodiment of such a system is described below with respect to FIG. 1.

FIG. 1 depicts a block diagram of a system 100 configured to provide employee motion tracking that can include a motion tracking wearable element, in accordance with certain embodiments. The system 100 may include an employee management system 102, which may be coupled to employee data 104, either directly or through a network. The employee data 104 may be stored in a database and may include movement data, location data, signal strength data, timing data, other data, or any combination thereof The employee management system 102 may communicate with a base unit 106 directly or through a network 110, such as the Internet. The base unit 106 may interface with one or more wearable elements 108, such as badges or smart cards, to retrieve the data and to recharge batteries associated with the wearable elements 108. In some embodiments, the base unit 106 may include a camera 109 configured to capture an image associated with a user when he or she checks in or checks out (i.e., removes a wearable element 108 or returns the wearable element 108 to a docking feature of the base unit 106. The base unit 106 may communicate the data to and receive data from the employee management system 102. In certain embodiments, the base unit 106 may be located at a building or job site where the employee is working. In other embodiments, the base unit 106 may be located at an employer's headquarters, and the employees may check in and check out at the headquarters at the beginning and the end of the shift, respectively.

The wearable elements 108 may be worn by one or more employees 112. The wearable elements 108 may be configured to collect movement data and to store such data together with timing information in a memory within the wearable element 108. The wearable elements 108 may include one or more magnetometers, one or more accelerometers, one or more gyroscopes (e.g., tri-axial gyroscopes), an altimeter, and one or more other sensors to capture the movement data. Further, the wearable elements 108 may include a transceiver, such as a wireless transceiver, a radio frequency identifier, or other wireless signaling element, which may communicate with one or more transceivers, such as transceiver 114, to receive signals and optionally to transmit data. In some embodiments, the wearable element 108 may include a transceiver, such as a SIM card or a network transceiver, which may allow communication over a wireless network without the need for an intervening device to allow transmission of the movement data to at least one of the bae unit 106 and the employee management system 102. In some embodiments, the wearable element 108 may include one or more antennas or other radio frequency (RF) receiving devices configured to receive signals from RF transmitters, which may be distributed throughout a structure.

In certain embodiments, the movement data may be correlated to time data from a clock (internal to the wearable element 108, derived from a beacon signal from a transceiver 114, or determined from another signal or source). Further, the movement data may be correlated to position data derived from a global positioning satellite (GPS) signal, based on signal strength of multiple beacon signals (triangulation), from electronic door lock information, from another source, or from any combination thereof.

In some embodiments, the movement data may be correlated to timing and position data and processed by a processor internal to the wearable element 108. In other embodiments, the movement data, associated timing data, and associated position data may be provided to one of the base unit 106 and the employee management system 102 and the base unit 106 or the employee management system 102 may process the received data. In some embodiments, the processor of the wearable element 108, the base unit 106, the employee management system 102, or any combination thereof may process the data to determine particular physical movements representing tasks and optionally to determine activity intensity associated with such movements for each user. In certain embodiments, the term “activity intensity” may refer to a percentage of activity or movement time relative to a total time. Other measurements of the activity intensity may also be used.

In an example, custodial personnel may attach the wearable elements 108 to their clothing and the movement data collected by the wearable elements 108 may be stored in a memory of the wearable element 108 and automatically communicated to at least one of the base unit 106 and the employee management system 102. In certain embodiments, the receiving device may automatically process the movement data and the location data to determine when, where, and whether particular tasks (such as emptying a garbage can, mopping the floor, vacuuming, and so on) were performed. Further, the receiving device may automatically process the movement data to determine a percentage of time the particular user was performing work-related activities as a percentage of the total amount of time (i.e., an activity intensity).

In certain embodiments, the processing devices (processors, controllers, etc.) may be configured to determine one or more actions or tasks based on the movement data. The processor(s) may compare a motion signature for each movement against the movement data (and optionally to the location data) to determine what action corresponds to the sequence of movement data and to determine what task corresponds to the action. Thus, the processing devices may determine whether a task was performed. In some embodiments, the determination of the motion(s) may be made in real-time or may be delayed.

In some embodiments, the wearable element 108 may initiate, such as via a user input, a training mode that allows the processing device(s) of the wearable element 108 to learn a motion signature associated with a specific movement or combination of movements as performed by the particular user. Upon initiation of the training mode, the user may be instructed to perform one or more activities (such as via an audio prompt) and the user may be further instruction to provide an indication of the start of the activity and the completion of the activity. The indication may include a button press, an audio signal, or some other indication. After motion data corresponding to a sequence of actions are captured, the training mode may be complete, and subsequent performance of such actions may be readily detected by comparing movement data to the data acquired during training.

In certain embodiments, the transceivers 114 may provide beacon signals, which may be received and recorded by the wearable elements 108 together with an associated beacon identifier. In some embodiments, the transceiver 114 may be wireless network transceivers configured to provide network accessing using IEEE 802.11x type network communication protocols. The transceivers 114 may be installed at a facility at pre-determined positions. The relative signal strengths of the recorded beacon signals may be indicative of the wearer's physical location relative to each transceiver 114, which strengths may be analyzed to determine an approximate position of the user at a point in time. In certain embodiments, the transceivers 114 may transmit a radio frequency (RF) signal, which may be received by an RFID antenna within the wearable elements 108. The RFID antenna within the wearable elements may respond to the RF signal by producing a responsive RFID signal, which may be captured by the transceiver 114 and sent to the base unit 108 (or to the employee management system 102) through a communications link, which may be a wired or wireless communications link. In other embodiments, the wearable element 108 may record samples of the RF signal and may provide the RF signal data with the motion data at a later time.

In certain embodiments, the wearable elements 108 may send motion and timing data to transceiver 114, which may communicate the motion and timing data to the base unit 108 for subsequent communication to the employee management system 102 (or may communicate the motion and timing data to the employee management system 102 via the network 110. In certain embodiments, the wearable elements 108 may download their stored information when inserted into the base unit 106.

Some employees may be out of range of the one or more transceiver 114, in which case the wearable elements 108 may record the movement data and associated timing information. Subsequently, the employee 112 may dock the wearable element 108 into the base unit 106 for recharging, and the data may be retrieved by the base unit 106 and transmitted to the employee management system 102 for further processing and analysis and for storage in employee data 104. Alternatively, the employee 112 may subsequently enter within communication range of the base unit 106 and the wearable element 108 may download its data to the base unit 106.

In certain embodiments, the wearable element 108 may track one or more motions of an employee throughout the work day. The wearable element 108 may collect movement data over a time period, such as a work shift, and may communicate the movement data to the base unit 106, to the management system 102, or both. The wearable element 108 may also communicate timing information, such as a date stamp or timestamp, to the management system 102. In certain embodiments, the wearable element 108 may also communicate RF signal strength data to the management system 102 indicating the strength of the RF signal it received at the time the motion data was captured.

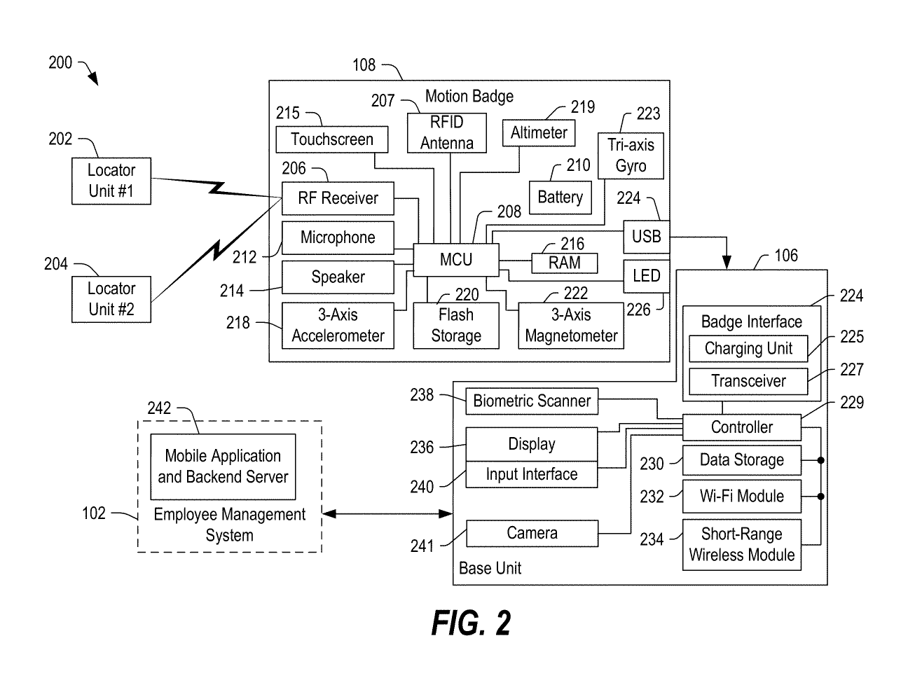

While the system 100 is presented in the context of employee management, it should be appreciated that the system 100 may be configured to use in any environment in which it may be desirable to track and monitor movement of the participants. For example, in physical training context, performance of training activities, schedules, and rest periods may be monitored for peak performance training and coaching purposes. In other work environments, work activities may be monitored for safety, efficiency and other purposes. In some embodiments, work activities may be monitored for a movement intensity. An example of a system to track movements is described below with respect to FIG. 2.

FIG. 2 depicts a block diagram of a system 200 to provide employee motion tracking that can include a movement tracking wearable element according to certain embodiments. The system 200 can include two or more radio frequency signal sources, such as a pair of locator units 202 and 204, which may be deployed at a job site. Each locator unit 202 and 204 may transmit radio frequency signals, which may be received by the wearable element 108. In some embodiments, the locator units 202 and 204 may be wireless access points that may provide radio frequency signals for wireless network access by various computing devices. In this instance, the relative strength of the radio frequency signals may be used to locate the device approximately using triangulation.

In certain embodiments, the locator units 202 and 204 may be special purpose devices configured to transmit radio frequency beacon signals. The locator units 202 and 204 may be designed to plug into an AC power outlet. In certain embodiments, each locator unit 202 and 204 may include an MCU (not shown) that may be coupled to a transmitter (not shown), which transmits a unique identification (ID) number at a regular interval. The wearable element 108 may record the identification value, the associated signal strength and the time.

Once the data is uploaded, the employee management system 102 may use this data to calculate or derive the approximate location of an employee at a given time, correlated to the movement data at that same time. In a given building where employees will be working, locator units 202 and 204 (and other locator units) may be located where the wearable elements 108 can receive signals from two or more locator units at any given location of the employee, which signals can be used to determine the location of the employee (for example based on their signal strengths individually and relative to one another). In certain embodiments, the beacon signals may be within a particular frequency range, such as 900 MHz or another range selected so as to not interfere with IEEE 802.11x type transmissions. Alternatively, the beacon signals may be RF signals configured to excite RFID antenna within the wearable elements 108. In certain embodiments, GPS, an altimeter, or both (sometimes in combination with the beacon signals) may be used to determine a location of a user.

The system 200 further can include the wearable element 108, the base unit 106, and the employee management system 102. The wearable element 108 (e.g., a motion badge worn by the employee) may include an RF receiver 206 configured to receive the beacon signals. The RF receiver 206 may include signal processing elements, such as low noise amplifiers, comparators, analog-to-digital converters, and the like and may be configured to communicate received information to a processor, such as a microcontroller unit (MCU) 208. The wearable element 108 may further include an RFID antenna 207 configured to receive an RF signal from an RFID tag reader and to communicate a unique identifier to the RFID tag reader in response to the RF signal. The wearable element 108 may be configured to operate as a programmable security badge to provide electronic access to secure areas of a building.

The wearable element 108 may further include a battery 210, a microphone 212, a speaker 214, a display or touchscreen 215, random access memory (RAM) 216, a tri-axis accelerometer 218, an altimeter, a flash storage 220, a tri-axis magnetometer 222, a tri-axis gyroscope 223, a global positioning system (GPS unit), a digital altimeter circuit, an input/output (I/O) interface, such as a universal serial bus (USB) port 224, a light emitting diode (LED) 226, or any combination or variations thereof. The MCU 208 may be powered by the battery 210. The MCU 208 may collect data via periodic read requests to the following sensor devices (connected to the MCU 208 via a serial bus (not shown): the altimeter 219, which provides altitude information (i.e., what floor is the badge on); the tri-axial magnetometer 222, which provides orientation data indicating a direction the worker is facing; the tri-axial accelerometer 218, which provides movement data corresponding to movement of the employee; the tri-axis magnetometer 222 configured to provide directional data corresponding to a direction the employee (or the wearable element) is facing; the tri-axial gyroscope 223, which may provide orientation data corresponding to the movement of the employee, and the RF receiver 206, which provides data related to the beacon signals to the MCU 210 to determine approximate location of worker via received signal strength analysis.

In certain embodiments, the MCU 208 may monitor diagnostic data, such as the charge level of the battery 210 and a number of write errors of the flash storage 220. Such collected data may be stored temporarily in the RAM 216 and may later be copied from the RAM 216 to the flash storage 220. Further, in certain embodiments, the MCU 208 may control the LED 226 to provide a visual status indication via different light color or patterns. In certain embodiments, the MCU 208 may control the speaker 214 to play different tones via MP3 files to give low battery indications, transceiver failure indicators, other alerts, or any combination thereof. In certain embodiments, the MCU 208 may utilize the microphone 212 to detect speech and conversation, and to timestamp the start and stopping points of speech. In some embodiments, the MCU 208 may process the audio data to determine tones (e.g., commands, casual talk, etc.), which information may be analyzed, in part, to determine a work intensity. In certain embodiments, the wearable element 108 may record the points of tonality of the conversation and may compare that tonality to a differing tonality and record those points separately. Subsequently, the employee management system 102 may process the recorded points and may determine if the tones were consistent (employee talking only) or differing tones (the employee was having a conversation with someone else near them, issuing commands, and so on). Further, in some embodiments, the MCU 208 may process the audio data to determine work activities, such as the sound of vacuuming, a toilet flushing, a power washer, a lawn mower, a weed-eater, a leaf blower, and so on. The audio data may be used to disambiguate work versus non-work related activities from tonality, and not just speech. The audio data can be recorded and analyzed and the tonality of different sound signatures for each activity can be isolated and compared to a data set, similar to motion signatures.

The base unit 106 may include one or more interface ports (e.g. USB), such as a multiple slot charging and data transfer circuit 228, flash storage 230, an Ethernet circuit to provide wired or wireless Ethernet communications 232, a Bluetooth® or other short-range wireless transceiver 234, and other circuitry. Further, the base unit 106 may include a liquid crystal display (LCD) screen 236 or other display, a biometric input element, such as a biometric fingerprint scanner 238, and an input element, such as a keypad 240. In certain embodiments, the LCD screen 236 and the keypad 240 (and optionally the fingerprint scanner 238) may be combined into a touchscreen interface. In some embodiments, the base unit 106 may also include a camera 241 configured to capture a digital image of a worker interacting with the base unit 106.

In certain embodiments, the base unit 106 may provide a gateway to communicatively couple wearable elements 108 to the employee management system 102, providing, in certain implementations, a central point of interaction for employees, badges, and the mobile application. The base unit 106 may include a session border controller (SBC) (not shown), which may be powered by standard 110V AC. The base unit 106 may further include badge interface 224 including a charging unit 225 and a transceiver 227 configured to communicate with the wearable element 108 to charge the battery 210 and to retrieve data from the flash storage 220. In some embodiments, the charging unit 225 may be configured to recharge the wearable element (motion badge) 108 inductively.

Further, the base unit 106 may include a controller 228 coupled to the badge interface 224 and coupled to a data storage device 230, a wireless fidelity (WiFi) transceiver 232 (such as a transceiver configured to provide an 802.11x communications link), and a short-range wireless module 234 (such as a Bluetooth® transceiver). In certain embodiments, the base unit 106 may further include a fingerprint scanner 238 coupled to the controller 228. The fingerprint or biometric scanner 238 may be used for an employee to “clock in” and “clock out”. Clocking in and clocking out may represent timecard events for a work shift, and the base unit 106 can attempt to match the scanned fingerprint to a local set of stored employee information to authenticate the employee. When an employee “clocks in”, the base unit 106 can associate the employee's ID with a selected one of a plurality of wearable elements 108 based on which of the wearable elements 108 is removed from the multiple card slots (such as a 20 card slot interface), thereby avoiding having to assign each employee a single, unique wearable element 108. In some embodiments, the clocking in and clocking out may be accomplished by interacting with the input interface 240 and removing a wearable element 108 from the badge interface 224.

In certain embodiments, the display 236 and the input interface 240 may allow for basic “menu” capabilities and may be accessed by an authorized user to initiate manual upload of collected data and timecard events to the employee management system 102. If an automatic data upload is preferred, the base unit 106 (or the wearable elements 108) can be configured (via the input interface 240, the display 236, or a combination thereof) to automatically send the data to the employee management system 102 via a communication network, which may be the Internet, a local area network, a cellular, digital or satellite network, or any combination thereof. The base unit 106 may have slots for multiple wearable elements 108 (e.g. badges) to connect or “dock” (e.g. via interface connectors mounted at the bottom of each slot 228) for recharging a battery within the wearable element 108, downloading of collected data from the wearable element 108, providing instructions to the circuitry of the wearable element 108, or any combination thereof. In certain embodiments, expansion units may be added to the base unit 106 to allow for connection of more of the wearable elements 108. In certain embodiments, each expansion unit may include additional slots. Collected data and timecard events may be stored locally in a high capacity, non-volatile memory 230 (e.g. SD card or SSD) coupled to the SBC. In certain embodiments, the base unit 106 can communicate with mobile devices running a mobile application, either wirelessly (e.g. via Bluetooth pairing or secure Wi-Fi connection) or using a cable (e.g. via a USB port of the badge interface 224).

In certain embodiments, the display 236 may allow the base unit to display various messages to employees at the beginning or end of their work shift. The display 236 can provide a visual interface (such as a graphical user interface) including information about his or her work day (e.g., how many steps the employee took, exactly how many hours he or she worked, his or her total hours for that week, other information, or any combination thereof); can display survey information (e.g., “Did you have an accident and injury free work shift? Answer YES or NO.”); can provide information about upcoming holidays or vacation, etc. The base unit 106 can be customized to display a wide variety of messages and information, and the employees can even submit requests or update inventory items by interacting with menu items via the input interface 240 at the base unit 106. If the base unit 106 is connected to a network 110 (such as the Internet), the base unit 106 can communicate information to the employee management system 102 (in real time or substantially real time). Such communicated information may include information about the employee's shift, information retrieved from the wearable element, information about the answers to each of these questions, and so on.

The employee management system 102 may include a mobile application program interface and backend server 242, which may communicate with the base unit 106. In certain embodiments, the employee management system 102 may be communicatively coupled to the base unit 106 through the network 110. In certain embodiments, the mobile application program interface and backend server 242 may include a program interface to allow communication with a mobile application (or mobile app.), which can be an application configured for operation on a remote computing device (such as a smart phone, such as with an iOS operating environment, an Android operating environment, or other operating environments). The mobile application may be configured for operation on smart phones, tablet computers, or other portable computing devices.

In certain embodiments, the mobile application and backend server 242 may operate as a relay or proxy for data transfer between the base unit 106 and the employee management system 102 (or backend server). In certain embodiments, the mobile application and backend server 242 may also facilitate a number of administrative functions. For example, if a manual data collection is desired, the mobile application and backend server 242 may retrieve the collected data from the base unit 106 or the wearable element 106 (via a wired or wireless connection) and may send the collected data (securely) to the backend server. In the event of a transmission failure or transmission error, the mobile application and backend server 242 may retransmit the data and may send a notification (via text message or email) to an administrator. Once the employee management system 102 has acknowledged successful receipt of the data, the mobile application and backend server 242 can notify the base unit 106 so that the base unit 106 can delete any unneeded data. Additionally, the mobile application and backend server 242 can be used to perform certain administrative tasks, such as adding new employees, removing former employees, creating notes related to employees, writing messages to employees, and so on.

In certain embodiments, the mobile application and backend server 242 may include a recording feature that allows the mobile application to record motion signatures by an individual. In an example a trainer or manager may utilize the mobile application and backend server 242 to select an activity that he or she is about to record on a specific wearable element 108 to timestamp the interval for that wearable element 108 so that the employee management system 102 can know when the activity was started and stopped.

In certain embodiments, the employee management system 102 may store and process data from multiple job sites. A base unit 106 may be deployed at each job site or may be deployed at a central office where the individual employees may log in and log out and from which the individual employees may be deployed.

In certain embodiments, the base unit 106 may serve as a charging station and a data collection unit. In an example, when checks in at a central office, he or she may provide identifying information, such as a username and password, a biometric signature (such as a thumb print) via a biometric finger print scanner 238 located on or attached to the base unit 106, or through some other means. The base unit 106 may authenticate the employee input by checking a database or file of known employees. Once the base unit 106 has successfully identified the identifying information as corresponding to a known employee, the base unit 106 may provide information on the display 236 of the base unit 106. In certain embodiments, the display 236 may present instructions from a manager or other information, such as information the employer wants the employee to read upon check in. The employee may then remove his or her wearable element 108 from the base unit 106, which causes a clock to start for the employee's work day and which cause the base unit 106 to associate the particular wearable element 108 with the employee. Further, in some embodiments, the base unit may use the camera 241 to capture an image of the employee when the wearable element 108 is removed from the badge interface 224, when the wearable element 108 is returned to the badge interface 224, and so on. In some embodiments, the camera 241 may capture an image at log in and log out. The clock may be within the wearable element 108, within the base unit 106, or both. The employee may then attach the wearable element 108 on his or her clothing in a pre-determined location, such as on the wearer's left pectoral area.

In certain embodiments, the wearable element 108 (or motion badge) may be a small rectangular shaped badge, such as a portable, credit-card sized (or business card holder sized) data-collection device, which may be worn by the employee during his or her work shift. In certain embodiments, the wearable element 108 may be approximately 1.5 inches wide by 3 inches long by ⅛ inch thick. In certain embodiments, the wearable element 108 may include a housing formed from opposing injection molded plastic sidewalls defining an enclosure sized to fit an electronic circuit including the components depicted within wearable element 108 in FIG. 2. The tri-axial accelerometer(s) 218, the altimeter 219, the tri-axial magnetometer(s) 222, and the tri-axial gyroscope 223 may be within the housing of the wearable element 108 and may be used to track the employee's movements, altitude, and direction. In certain embodiments, the collected data (including motion signatures or action signatures) may be stored in the memory 220 throughout the work day. The RF receiver 206 may receive location information from the locator units 202 and 204 as the employee moves around the jobsite and the MCU 208 may correlate the location information, timing information, and motion information prior to storage in the flash storage 220.

Further, the wearable element 108 may include a visual indicator, such as an LED, display, or touchscreen 215. There may be a button that allows a user to cycle through different displayable metrics or options on a display or to initiate a training operation. Additionally, the wearable element 108 may include circuits, software, or any combination thereof to provide the following features: wireless network connectivity (e.g. WIFI, Bluetooth, cellular, satellite, etc.), a SIM card, memory expansion slot(s), a camera, 215, a heart rate monitor, or any combination thereof.

In certain embodiments, at the end of the shift, the employee may return the wearable element 108 to one of the card slots of the badge interface 224 of the base unit 106. Once the wearable element has been returned, the clock may time-stamp the return and may stop the clock on that employee's work day. At this point, the movement data in the flash storage 220 may be communicated to the base unit 106, which may transmit the data to the employee management system 102. Upon receipt of the data by the employee management system 102, the employee management system 102 may communicate a release command to the base unit 106, which release command may cause the base unit 106 to purge the movement data from the flash storage 220 of the wearable element 108, clearing memory space for the next use or employee. The base unit 106 may store all of the movement data for multiple wearable elements 108 for various employees and may send the aggregated information to the employee management system 102 by a manual upload, via an automatic upload at the designated time intervals using the network connection, via a mobile application, or any combination thereof.

However, in some embodiments, the base unit 106 can merely charge the battery 210 of the wearable element 108; and the wearable element 108 can include a transceiver to communicate with the server 242. For example, the wearable element 108 may include a SIM card or WIFI card to allow communication with the server 242 via a wireless network, without the base unit 106.

The employee management system 102 may collect data from multiple wearable elements 108 from various job sites. The employee management system 102 may serve as the processing unit that can analyze and interpret the motion and location data. The employee management system 102 may analyze the motion signatures from each card and may turn that data into information that can be useful to a person reviewing the data. In certain embodiments, the employee management system 102 may process the movement data to determine an exact type of work and the times that each type of work was started and stopped. The employee management system 102 may track total time spent on a specific task as well as the rate and quantity of the individual tasks that make up the total time spent on that type of work. In an example, the employee management system 102 may determine a task productivity rate according to the following equation:

Task Productivity rate=Number of task instances/total time spent on task (1)

In an example, an employee wore a wearable element 108, which was assigned to employee #323. The employee management system 102 analyzes the movement data for that wearable element, and determines 42 trash pickup signatures totaling 2 hours spent on trash pickup. The employee management system 102 may determine that the user has a task productivity rate of 21 trash tasks per hour, which corresponds to (42 tasks/2 hours=21 tasks/hour). This task productivity rate provides a quantifiable measure, which can be compared to another employee who has a trash productivity rating of 15 trash tasks/hour rating.

In an alternative embodiment, the system 102 may analyze the data to determine a work intensity, which may reflect a percentage of overall work time that was spent by the worker in work-related activities. Such activity intensity may be used to compare efficiencies and work ethics of the various employees. Activity intensity may be determined according to the following equation:

Activity Intensity=(Action time)/(total time) (2)

In certain embodiments, the employee management system 102 may store the data and the calculated productivity information in a database, such as the employee data 104 in FIG. 1. Further, the employee management system 102 may assemble the movement data, the calculated productivity information, other information, or any combination thereof into a visual or graphical interface (e.g. a dashboard) or other user interface, which may be used to present information to a user, such as via a website or mobile application. In some embodiments, the dashboard may provide to an employer visibility into an employee's activity intensity, so that an employer can identify his/her best workers.

In certain embodiments, the employee management system 102 may have the ability to push alerts and reports to a destination device, such as a user's computer or smart phone. Further, the employee management system 102 may allow reports to be pulled (requested) by or pushed (scheduled to be sent) via email, text, or web link. In certain embodiments, the user interface may include user-selectable elements or options that allow a manager to create custom reports for individual or multiple employees over whatever date or time range the manager chooses.

In certain embodiments, the employee management system 102 may include standardized reports (or report templates) that can show exception cases of wasted time or nonproductive work, unsafe activities, or other information. In certain embodiments, the employee management system 102 may include other standard reports that can rank workers and compare their productivity to their coworkers by specific tasks or groups of tasks. In certain embodiments, the employee management system 102 may collect data corresponding to basic human (or other) movements and corresponding to location data where such movements occurred. Subsequently, the employee management system 102 may analyze the collected data to accurately correlate portions of the collected data to a category of action or activity (i.e., task or movement) being performed.

In certain embodiments, the employee management system 102 may allow upload or reception of data and timecard events via the mobile application or automatic data transfer over the Internet (using a secure connection). In certain embodiments, the employee management system 102 may perform data analysis and correlation to an action or activity performed by an employee throughout each work shift (storing both raw and analyzed data), may calculate approximate locations of employee throughout each work shift, and provide “dashboard” data for a web or mobile portal. In certain embodiments, the employee management system 102 may generate reports for the portal. In certain embodiments, the employee management system 102 may act as the central repository for collected movement data, timecard events, employee and organization information, building maps where employees are working, locator unit locations for those building maps, etc.

To ensure a secure transfer of data, the employee management system 102 may include both a secure transport layer and login credentials. In certain embodiments, the employee management system 102 may store the data as regular files (e.g. incoming uploaded data, building maps) or in a database (e.g. collected Motion Tag data, timecard events, employee and organization information, Locator Unit locations), as appropriate. Further, the employee management system 102 may derive the approximate location of an employee during his or her work shift through analysis of locator unit signals in the collected data from the wearable element 108. The strength of the signal may be indicative of the proximity of the wearable element 108 to the particular locator unit 202 or 204. In certain embodiments, the employee management system 102 may perform database lookups for locator unit IDs in the collected data, and may use pre-defined location of those locator units to infer the general location of the employee at that point in time. In certain embodiments, the employee management system 102 may categorize actions or activities performed by an employee during his or her work shift through analysis of collected data from the wearable element 108. Some action or activity categorizations include, but are not limited to: walking, running, vacuuming, trash pickup, dusting, mopping, cleaning windows, cleaning bathrooms, cleaning break rooms, riding an elevator, climbing stairs, carrying trash or recycling to a designated location, other activities, or any combination thereof. As mentioned above, sounds and motion data may be analyzed to detect the various activities.

In certain embodiments, the employee management system 102 may categorize actions or activities by executing server-side scripts or instructions, which may be used to examining the data (including employee location) to match a motion “signature”, an audio “signature”, or both associated with one of the action or activity categories. In certain embodiments, the employee management system 102 may determine a signature match between the movement data, the audio data, or any combination thereof, and may identify a task and a “percent confident” value, indicating a probability that the movement data, the sound data, or a combination thereof corresponds to the activity or task. In certain embodiments, the employee management system 102 may determine that the movement data or the sound data may correspond to more than one task, the activity may be classified according to the highest “percent confident” value. For any portions of a work shift that the employee was active but that the movement data or sound data does not match a known task signature, those times may be classified as “uncategorized”. For any times in a work shift that the employee was not active, those times may be categorized as “inactive”.

In some embodiments, the wearable element 108 may initiate, such as via a user input, a training mode that allows the processing device(s) of the wearable element 108 to learn a motion signature associated with a specific movement or combination of movements as performed by the particular user. Upon initiation of the training mode, the user may be instructed to perform one or more activities (such as via an audio prompt) and the user may be further instruction to provide an indication of the start of the activity and the completion of the activity. The indication may include a button press, an audio signal, or some other indication. After motion data corresponding to a sequence of actions are captured, the training mode may be complete, and subsequent performance of such actions may be readily detected by comparing movement data to the data acquired during training.

The management system 102 can analyze and report (via electronic messages, a display, or both) the movement data. In certain embodiments, the management system 102 may analyze the movement data over time or during discrete time intervals. The management system 102 can allow a manager or employer to determine what activities an employee performed, such as during a work day or work week, without actually monitoring the employee in person. Further, the management system 102 may allow an employer or manager to determine each task (i.e. activity) the employee performed, the order in which the task was performed, the amount of time used for performance of each task, the absence of activity (e.g. the absence of work), the employee's productivity, other data, or any combination thereof. In some embodiments, the manager or employer may use the data to determine an activity intensity of each employee and to compare employee productivity. Further, such information can be valuable to a business to help determine the amount of time required to complete tasks, to determine if tasks are being completed, to help determine productive and non-productive workers, or any combination thereof.

In certain embodiments, the wearable element 108 may track location information as well as movement information. For example, the location information may indicate where workers are within a job site. The wearable element 108 may correlate and store movement and location data to record where and when employees performed work or to indicate where no work was being done, which information can be analyzed and presented to managers to provide insight into how the employees choose to execute their work patterns and which employees are moving in productive patterns and which are not. In certain embodiments, the data gathering and subsequent analysis of the movement data, location data, and so on may be used for evaluation of productivity or activity intensity relative to other team members, relative to companywide and industry benchmarks, relative to other contestants in competitions, or any combination thereof. The data may also be used for other purposes.

In certain embodiments, the analysis of the movement data may be used to determine patterns of movement that confirm safe types and levels of movement and conversely to bring attention to patterns and discrete types of movement that suggest increased likelihood of repetitive or traumatic injury or poor performance. The data (movement and sound) may be analyzed to confirm superior productivity and efficiency for purposes of promotion, pay raises, and incentive pay. Further, the data may be analyzed to provide indicia by location exception or movement exception, with attendant flagging, of unproductive or potentially illicit activities that would endanger either the employee or the company's business operations. The data may be used to confirm or audit time-keeping data and to provide indicia of employees who are “ghosting” or filling in for the hired employee. Further, the picture data from the camera may be used to audit the login and logout information. In an example, absence of movement data after check-in may indicate ghosting. Further, verification (automatic or manual) of the image data may also be used to prevent ghosting. Alternatively, if the movement and location data precisely correspond to that of another worker, one of the workers may be ghosting for another worker. Other examples are also possible.

In certain embodiments, the movement or activity intensity data may be used to populate a gaming module, which may be utilized by participating employees to engage in competitions with other participants both intra-company and inter-company. Further, the movement data may be used to populate, analyze, and generate exceptions reports that can be electronically transmitted to designated management personnel for coaching follow up or for other management decision-making (such as hiring and firing decisions).

In certain embodiments, movement data collected by the wearable element 108 may be analyzed to determine particular activities. In certain embodiments, a particular activity performed by an employee may have a movement signature comprised of multiple movement measurements (motion data) taken or captured within a period of time. Examples of such actions may include, but are not limited to, walking, running, vacuuming, picking up trash, dusting, mopping, cleaning windows, cleaning bathrooms, cleaning a break room, riding an elevator, walking up and down stairs, emptying trash cans, carrying trash and recycling to designated areas, other activities, or any combination thereof. Each such activity may have a unique signature relative to the various multiple movement measurements, the location data, or both.

While the above-discussion has been focused on capturing movement data related to movements by human workers, the systems and methods described above can be used with respect to any moving animal (e.g. pets, service animals, etc.) or moving entity (e.g. factory robot, amusement park ride, etc.). The wearable element 108 (or badge) can be attached to anything that has a motion signature that can be recorded.

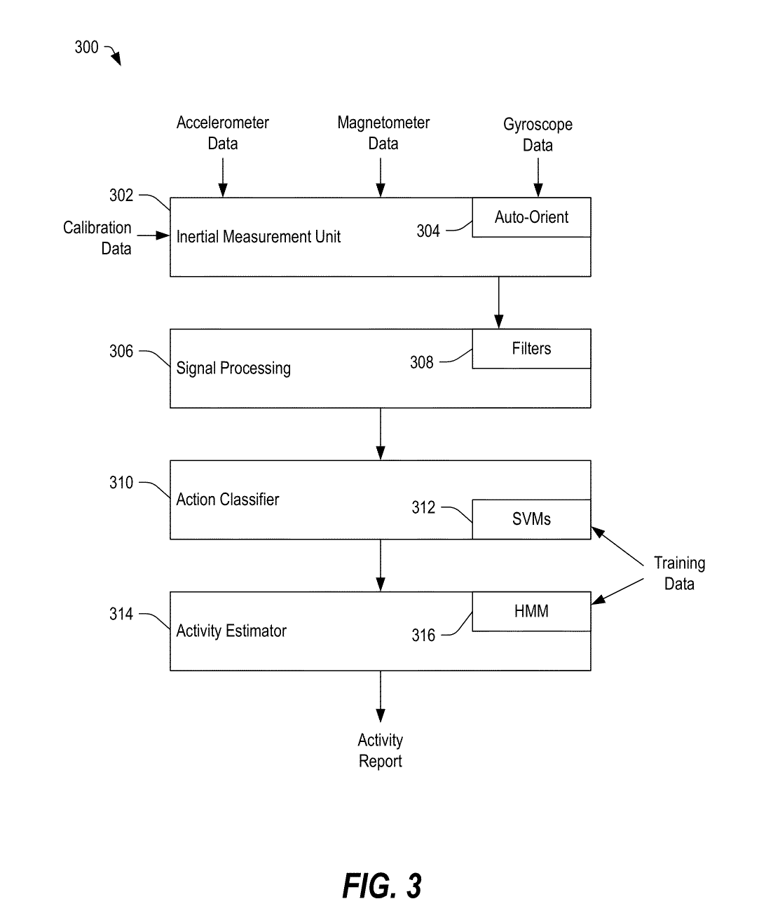

FIG. 3 depicts a block diagram of a system 300 to provide motion tracking, in accordance with certain embodiments of the present disclosure. The system 300 may include an inertial measurement unit (IMU) 302 configured to receive calibration data, accelerometer data, magnetometer data, gyroscope data, other data, or any combination thereof. The IMU 302 may include an auto-orient circuit 304, which may be configured to automatically determine an orientation of the wearable element 108. In certain embodiments, the IMU 302 may be part of the wearable element 108.

Further, the system 300 may also include a signal processing circuit 306 coupled to the IMU 302. The signal processing circuit 306 may include one or more filters 308. The signal processing circuit 306 may be part of the wearable element 108 or may be included within the base unit 106 or the employee management system 102.

Additionally, the system 300 may include an action classifier 310 coupled to the signal processing circuit 306. The action classifier 310 may include a support vector machine (SVM) 312, which may be configured to receive training data to disambiguate motion data to identify one or more actions.

Further, the system 300 may include an activity estimator 314, which may be coupled to the action classifier 310. The activity estimator 314 may include a Hidden Markov Model (HMM) module 316, which may be configured to receive training data to disambiguate actions to determine particular activities. In certain embodiments, the activity estimator 314 may provide an activity report configured to identify specific activities performed based on the motion data.

In some embodiments, the system 300 may implement (through dedicated hardware, application specific integrated circuits, field programmable gate arrays, or other hardware) a Human Activity Recognition (HuAR) algorithm. Using the HuAR algorithm, the system 300 may estimate user activities based on wearable sensor measurements. The sensors may record and report user movements via Micro-electromechanical Systems (MEMS) accelerometers, magnetometers, and rate gyroscopes. The system 300 may use sensor fusion, signal classification, and state estimate techniques to convert sensor data to likely activities, which can be summarized in a report. In certain embodiments, the system 300 may be used to monitor janitorial staff and, in particular, activities of interest, such as walking, resting, mopping, vacuuming, and removal/replacement of garbage receptacle bags and recycling containers.

In certain embodiments, the system 300 may be configured to receive environmental data, such as temperature, barometric pressure, and the like. Further, the system 300 may be configured to capture and store RF measurements, RF signal strength, directional information, other data, or any combination thereof. In certain embodiments, the HuAR algorithm framework may be extensible and can be adapted to different applications, such as monitoring of security and landscaping personal.

The IMU 302 may be configured to convert raw MEMS sensor data into orientation (heading, pitch, and roll) and coordinate acceleration. In some embodiments, the sensor data may include gravity component measurements. The signal processing circuit 306 may translate the IMU measurements into metrics such as bend angle, fundamental frequencies, and motion statistics. The action classifier 310 may be configured to transforms these metrics to a series of simple, discrete movements or action, such as no motion, step, bend, wiggle, etc. The activity estimator 314 can predict or disambiguate higher-level maneuvers (activities) based on the series of actions. The activities, which may include, for example, walking, resting, mopping, vacuuming, garbage pickup, can be used to generate reports that summarize work performed during a shift and to provide anomaly alerts, such as extended rest periods. While the above-discussion has focused on custodial activities, it should be appreciated that the activity detection can be used with respect to delivery drivers, nursing activities, construction, security, retail sales, and other industries.

In certain embodiments, the IMU 302 may perform four different functions: a correction/normalizer function; an auto-orient function; a magnetometer check function; and a sensor fusion function. With respect to the correction/normalizer function, the IMU 302 may receive calibration data collected during the wearable sensor's factory build and test procedure, and may apply the calibration data to raw data to produce normalized readings. The calibration data can include accelerometer biases, accelerometer gravity magnitude, magnetometer biases, magnetometer magnitude, magnetometer angle, gyroscope biases, and gyroscope rates. In certain embodiments, the factory calibration procedure can be replaced with an “auto-calibration” function that can derive the same info using field data.

With respect to the auto-orient function, the IMU 302 can estimate an up-vector (vertical direction) based on an average accelerometer value. If there is not a strong average value, which could be a consequence of the wearable sensor being removed or repositioned, the up-vector can be taken from a fixed amount of time after start of collection. The time can be based upon how long it will take for the average user to put on the sensor (i.e., to wear the sensor). The up-vector may be used to de-rotate sensor data, and can be used to produce metrics such as the bend angle.

With respect to the magnetometer check function, the IMU 302 may compare measured magnetometer and angle data against calibrated data to insure that sensor readings are not corrupted by electromagnetic interference caused by magnetic or ferrous material. For this function to operate correctly, the calibration data may be collected in the same region, i.e. state or country, within which the wearable element 108 may be used. In certain embodiments, the IMU 302 (or another device) may derive thresholds using representative field data.

With respect to the sensor fusion function, the IMU 302 may filter normalized and de-rotated data to produce orientation (heading, pitch, and roll) and coordinate acceleration measurements. In some embodiments, the IMU 302 may also utilize gravity measurement data. The IMU 302 can utilize bilinear interpolation to align incoming data, which is may be generated at different rates, and the internal state may be represented as a quaternion, so that the filters 308 can operate effectively at extreme bend angles (no gimbal-lock).

The signal processing circuit 306 may convert estimates from the IMU 302 into metrics to be used for discriminating between different actions. Such metrics may include bend magnitude, bend duration, accelerometer amplitudes, accelerometer fundamental frequencies, and accelerometer energies. To generate useful metrics, the signal processing circuit 306 may filter the IMU data using filters 308. In certain embodiments, the filter coefficients of the filters 308 may be tuned to optimize the signal-to-noise ratio for the training data set. The filters 308 or the signal processing circuit 306 may normalize the metric outputs to insure that approximately 95% of the training data metrics are within the range of −1.0 to 1.0 and are clipped to insure that the remaining 5% do not corrupt future calculations. In some embodiments, the signal processing circuit 306 may also process audio data to determine actions. By normalizing the metric outputs, the signal processing circuit 306 may be configured to classify the data without prioritizing the IMU metrics based on their absolute value.

The action classifier 310 may be configured to segment signal processing metrics from the signal processing circuit 306 into simple, discrete movements. In certain embodiments, the action classifier 310 may utilize one or more classification methods. In certain embodiments, the action classifier 310 may utilize a binary threshold classification method and a multi-class Support Vector Machine (SVM) method. In certain embodiments, the action classifier 310 may utilize a binary threshold to classify signals having actions highly correlated to one signal processing metric, e.g. the “no motion” action. The binary threshold may provide design simplicity, the ability to manually refine or tune results, and the ability to use the classifier without having to apply a training set. Further, the action classifier 310 may utilize multi-class SVMs to classify actions whose signal processing metrics are “fuzzy” or ambiguous, e.g., the “step” action. The multi-class SVM may provide optimal performance, assuming linear-inputs. The multi-class SVMs may be trained using one data set and validated using a different set. Other classification methods and systems can also be used. For example, linear classifiers may be used, such as logistic regression, multinomial logistic regression, probit regression, linear discriminant analysis, Naïve Bayes classifiers, and other linear classifiers. Further, various SVMs may be used, including least squares SVMs, or other SVMs. Other classifiers may include quadratic classifiers, decision trees, neural networks, learning vector quantization classifiers, and the like. The action classifier 310 may utilize run-length encoding and may reclassify movement data based on the duration of the movement to ensure that short duration events can be interpreted differently than long duration events, e.g. a two-second pause is a different event than a five-minute rest.

The activity estimator 314 may utilize a discrete Hidden Markov Model (HMM) 316 configured to estimate the underlying states (activities) given a sequence of observations (actions). For example, a garbage pickup typically includes a bend action, followed by a wiggle action (to dislodge trash from the container), then followed by another bend. However, the garbage pickup activity may include variations such as a bend, no-action, wiggle, and bend. The HMM 316 may provide a statistical model for identifying the most likely action sequence given a data set. Emission probabilities and transition probabilities can be trained against test data to maximize performance. Based on the output of the activity estimator 314, the system 300 can estimate how many of a specified activity (e.g., garbage collection) occurred in a shift or can evaluate the activities performed during a shift to detect and report anomalous behavior, such as extended breaks. The activity estimator 314 may generate reports, which can be used to assess productivity and to identify potential employee issues.

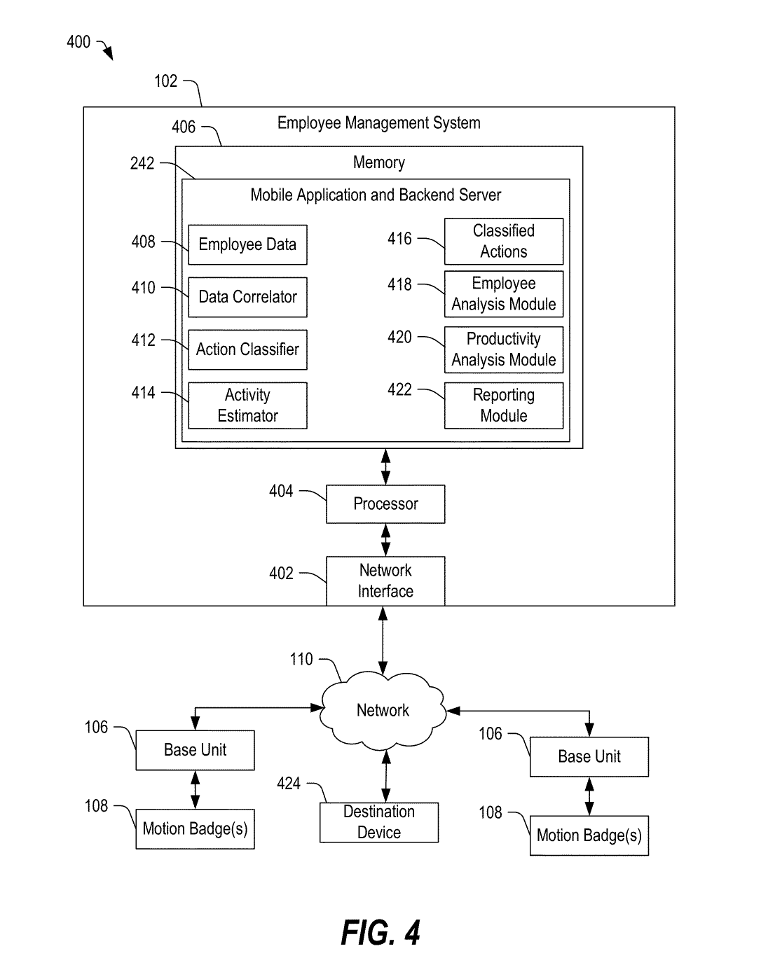

FIG. 4 depicts a block diagram of a system 400 configured to provide motion tracking, in accordance with certain embodiments of the present disclosure. The system 400 may include an employee management system 102 configured to communicate with one or more base units 106 through a network 110. The system 400 may also include one or more motion badges 108 configured to communicate with the employee management system 102 through a wired or wireless communication link (not shown), indirectly through the network 110, or via the base units 106. The employee management system 102 may be configured to communicate with one or more destination devices 424 through the network 110. The destination devices 424 may be computer devices.

In certain embodiments, the employee management system 102 may include a network interface 402 configured to communicate with the network 110. Further, the employee management system 102 may include a processor 404 coupled to the network interface 402 and a memory device 406. The memory 406 may include a mobile application and backend server 242, as described above with respect to FIG. 2. The memory 406 may further include employee data 408 and classified actions 416. The classified actions 416 may represent identified sequences of movements that correspond to particular actions.

The memory device 406 may further include a data correlator 410 that, when executed, may cause the processor 404 to process RF data from the wearable elements 108 to determine location data and to correlate the location data to the movement data to determine where particular actions were performed. The memory device 406 may also include an action classifier 412 that, when executed, may cause the processor 404 to determine actions corresponding to the movement data. The memory device 406 may further include an activity estimator 414 that, when executed, may cause the processor 404 to determine tasks corresponding to the determined actions.

The memory device 406 may also include an employee analysis module 418 that, when executed, may cause the processor 404 to correlate the tasks to a particular employee and to process the completion of such tasks by the employee in order to credit the employee for the work he or she performed. The memory device 406 may also include a productivity analysis module 420 that, when executed, may cause the processor 404 to evaluate a productivity level of a particular employee relative to a baseline, relative to other employees, relative to time, or any combination thereof. The productivity level may indicate how many tasks the employee completes within a period of time.

The memory device 406 may also include a reporting module 422 that, when executed, may cause the processor 404 to selectively generate an alert, which may be sent to the destination device 424 through the network 110. In certain embodiments, the alert may be sent when a productivity level of the employee falls below a first threshold level. In some embodiments, the alert may be sent when the activity is determined in an unauthorized location. In some embodiments, the alert may be sent when the productivity level of the employee exceeds a second threshold activity level. In certain embodiments, an employer may wish to reward an employee who exceeds the second threshold activity level and may wish to encourage an employee to work harder whose productivity level falls below the first threshold activity level. Other embodiments are also possible.

In certain embodiments, some or all of the functionality and data described above with respect to the memory 406 may be consolidated within a mobile application and backend server 242 and associated data. In certain embodiments, the mobile application and backend server 242 may include s employee management unit 102 and the base unit 106 may be combined. In certain embodiments, the functionality described above with respect to the employee management unit 102 may be distributed between the employee management system 102, the base unit 106, and the wearable elements 108. Other embodiments are also possible.

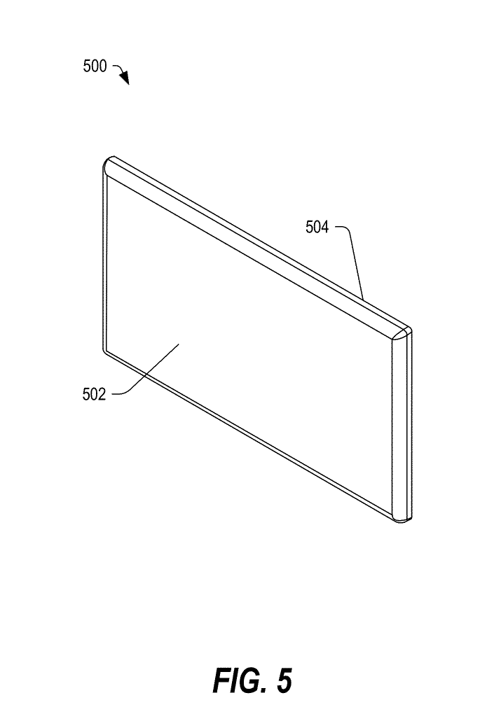

As discussed above, the wearable element 108 may be implemented as an employee badge that can include sensors and circuitry. An example of an implementation of an employee badge is described below with respect to FIG. 5, in accordance with certain embodiments of the present disclosure.

FIG. 5 depicts a perspective view of a movement tracking badge 500, in accordance with certain embodiments of the present disclosure. In certain embodiments, the movement tracking badge 500 is an embodiments of the wearable element 108 described above with respect to FIGS. 1 and 2. The movement tacking badge 500 may include a first portion 502 and a second portion 504, which may be configured to fit together along peripheral edges to form an enclosure sized to receive circuitry, including motion sensors, a battery, and other components, such as those shown and described with respect to FIG. 2. The first portion 502 and the second portion 504 may include a substantially smooth planar surface. In certain embodiments, the edges of the first portion 502 and the second portion may be beveled or curved to prevent the edges from catching on nearby surfaces.

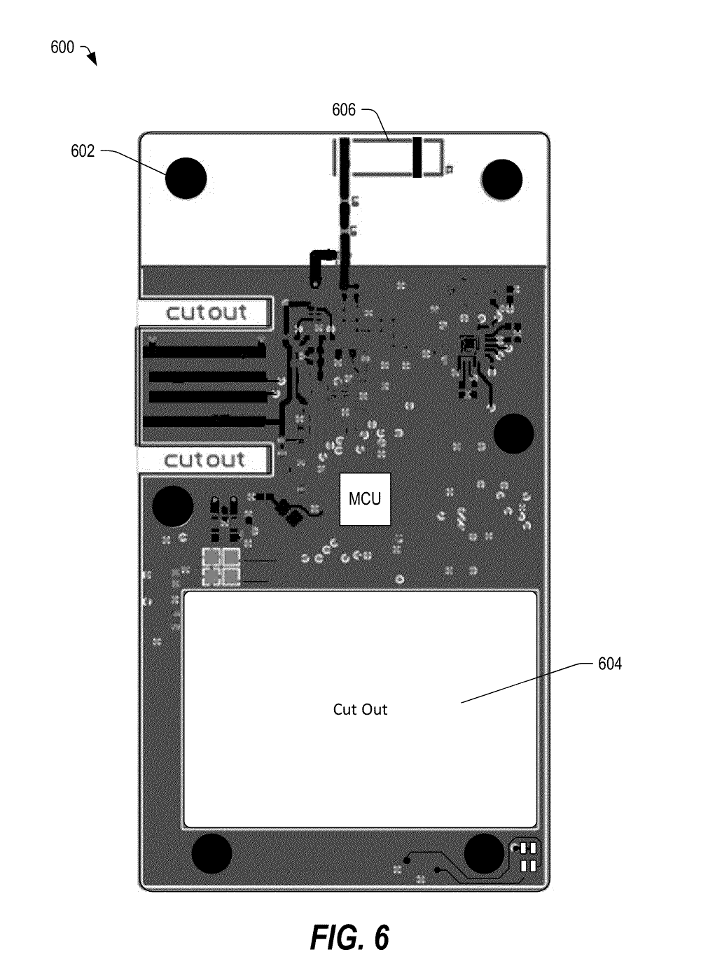

FIG. 6 depicts a diagram of a circuit 600 within a movement tracking badge 500 to provide employee motion tracking according to certain embodiments. In certain embodiments, the circuit 600 may be a printed circuit board including circuit components, such as those described with respect to the wearable element 108 in FIGS. 1 and 2 above. The circuit 600 may be the size of a business card or slightly smaller than a wearable employee badge 500 and may be sized to fit within the enclosure defined by the badge 500. The circuit 600 may include cut out areas, such as cut out area 504 configured to mate with features of an enclosure, and may include openings, such as opening 602, configured to receive male/female connecting structures configured to interconnect the first portion 502 and the second portion 504 of the housing 500. Further, the circuit 600 may include wire traces, conductive vias, and other circuit features to interconnect various circuit components, such as sensors, the MCU, receivers, antenna(s), and other circuit components and to couple the battery to various circuit components. In certain embodiments, the battery may be coupled to one or more of the components through a power management circuit (not shown).

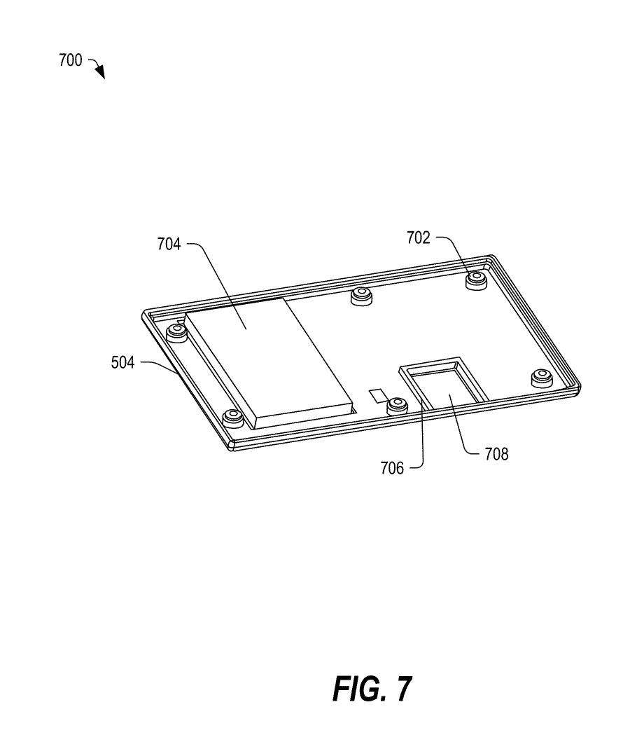

FIG. 7 depicts a perspective view of a portion 700 of the movement tracking badge 500, in accordance with certain embodiments. The portion 700 may include fastening elements 702 (e.g., a male connecting structure), which may snap into corresponding receiving elements (e.g., a female connecting structure) on an inside of a corresponding portion of the housing 500 in FIG. 5. Further, the portion 700 may include protrusions 704 and 708 sized to fit cutout areas, such as cut out area 704, of the circuit 600 in FIG. 5. Further, in certain embodiments, one of the protrusions 706 may define a ridge surrounding a recess 608 sized to fit a circuit feature, such as a processor, a transceiver circuit, a battery, or another component of the circuit 600.

In certain embodiments, the tracking badge implementation described above represents only one embodiment of numerous possible embodiments. The specific size and shape of the enclosure formed by the housing 500 may determine the corresponding size and shape of the circuit 600 in FIG. 6; however, the wearable element 108 (or badge) may be designed to have a suitable size and shape for the intended use. Further, though the above discussion of FIGS. 1-6 has focused on employees and employee task management, the wearable element 108 and the management system 102 may be deployed for use in other contexts, such as exercise, package tracking (to verify that the package remained in a desired orientation throughout transport, storage, and delivery, etc.), and so on.

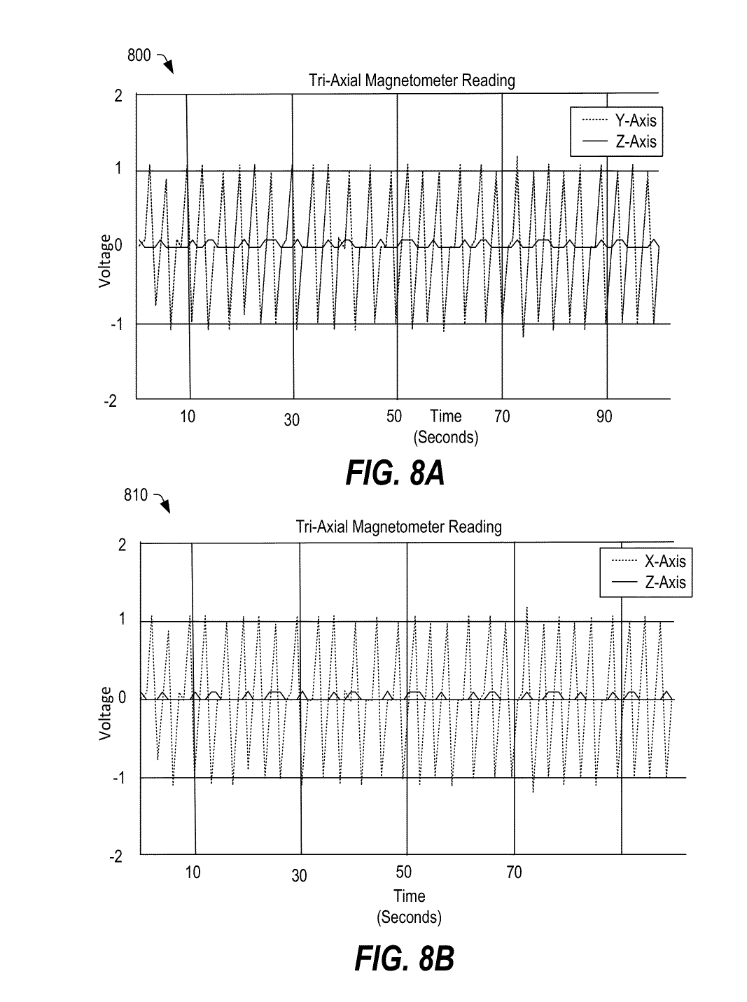

In certain embodiments, multiple sensors including magnetometers, accelerometers, and so on, may be used to determine the orientation and movement of the wearable element 108. Such sensors may be positioned within the wearable element and may generate electrical signals representing a magnitude of movement. In certain embodiments, such movements may produce electrical signals from multiple sensors that can vary along three axes over time, which electrical signals can be analyzed to determine tasks performed by an employee wearing the wearable element 108. One example of electrical signals that may be produced by multiple (tri-axial) magnetometers or by a tri-axial magnetometer is described with respect to FIGS. 8A and 8B below.

FIGS. 8A and 8B represent graphs of voltage versus time for a magnetometer signal indicating slight turning of the body left or right and returning to forward facing every second according to certain embodiments. Since the movements overlap on two axes, for illustrative purposes, the Y-axis and Z-axis data are presented in FIG. 8A and the X-axis and Z-axis data are presented in FIG. 8B.

Referring to FIG. 8A, the graph 800 represents movement in a y-direction and a z-direction (concurrently), as measured by a tri-axial magnetometer (or three fixed magnetometers). The graph 800 can include a first signal representing movement in the y-direction and a second signal representing movement in the z-direction. In the illustrated example, the signal corresponding to movement in the z-direction is close to zero, while the signal corresponding to movements in the y-direction varies between approximately one and minus one volt.

Referring to FIG. 8B, the graph 810 represents movement in an x-direction and a z-direction (concurrently), as measured by a tri-axial magnetometer (or three fixed magnetometers). The graph 810 can include a first signal representing movement in the x-direction and a second signal representing movement in the z-direction. In the illustrated example, the signal corresponding to movement in the z-direction is close to zero, while the signal corresponding to movements in the x-direction varies between approximately one and minus one volt. In certain instances, the signal representing movement in the x-direction may be slightly stronger (higher absolute value of the peak voltage) than the signal representing movement in the y-direction in FIG. 8A.

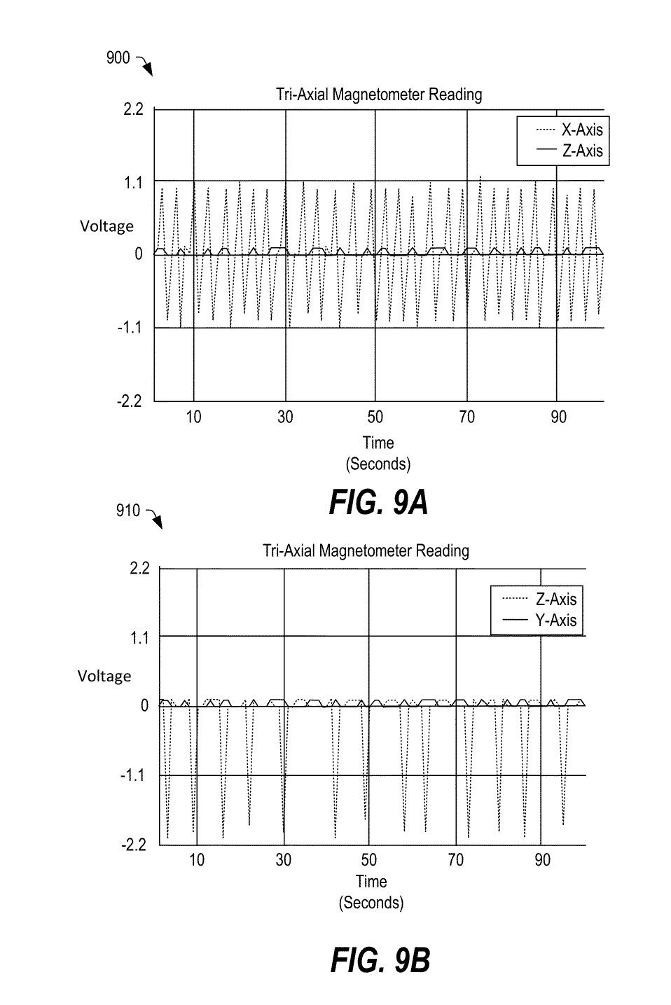

FIGS. 9A and 9B represent graphs of voltage versus time for an accelerometer reading indicating a back-and-forth movement in the “forward facing” axis occurring every second and a back-and-forth movement in the “up/down” (z-direction) axis occurring every few seconds according to certain embodiments. Since the movement data partially overlap on two axes, for illustrative purposes, the X-axis and Z-axis data are presented in FIG. 9A and the Y-axis and Z-axis data are presented in FIG. 9B.

Referring to FIG. 9A, the graph 900 represents movement in an x-direction and a z-direction (concurrently), as measured by a tri-axial accelerometer (or three fixed accelerometers). The signal representing movement in the x-direction is similar to that of the signals representing movement in FIG. 7. Movement in the z-direction occurs every few seconds (as determined by the signal), which is much less frequent than the signal corresponding to the back-and-forth movement in the x-direction.

Referring to FIG. 9B, the graph 910 represents movement in a y-direction and a z-direction (concurrently), as measured by a tri-axial accelerometer (or three fixed accelerometers). The signal representing movement in the y-direction varies within a range of voltages from just above zero to approximately −2 volts. Movement in the z-direction occurs every few seconds (as determined by the signal), which is much less frequent than the signal corresponding to the back-and-forth movement in the y-direction.

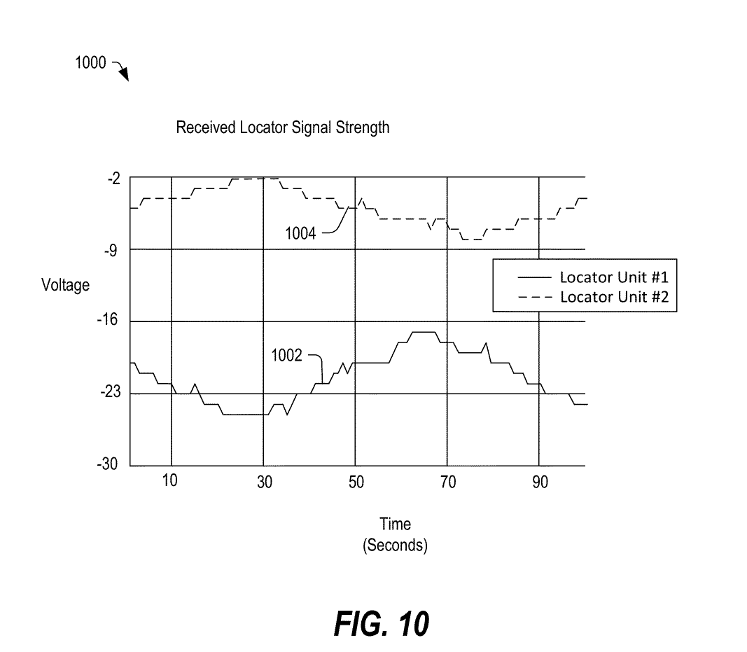

FIG. 10 depicts a graph 1000 of voltage versus time for two locator units according to certain embodiments. The graph 1000 can include a first signal 1002 corresponding to a first RF signal received from a first locator, such as locator 202 in FIG. 2. The graph 1000 further can include a second signal 1004 corresponding to a second RF signal received from a second locator, such as locator 204 in FIG. 2. As the employee moves around during the shift, the wearable element 108 is moved closer to or further away from one or the other of the locators, causing the signal strengths to vary over time, which signal strength may be determined from the corresponding voltage levels.

The system described in FIGS. 1-10 can be applied to any moving creature (e.g. pets, service animals, etc.) or moving entity (e.g. factory robot, amusement park ride, etc.). The motion badge (wearable element 108) could be attached to anything that has a motion signature that can be recorded, and the system may be trained to identify performance of particular tasks based on the motion signature.

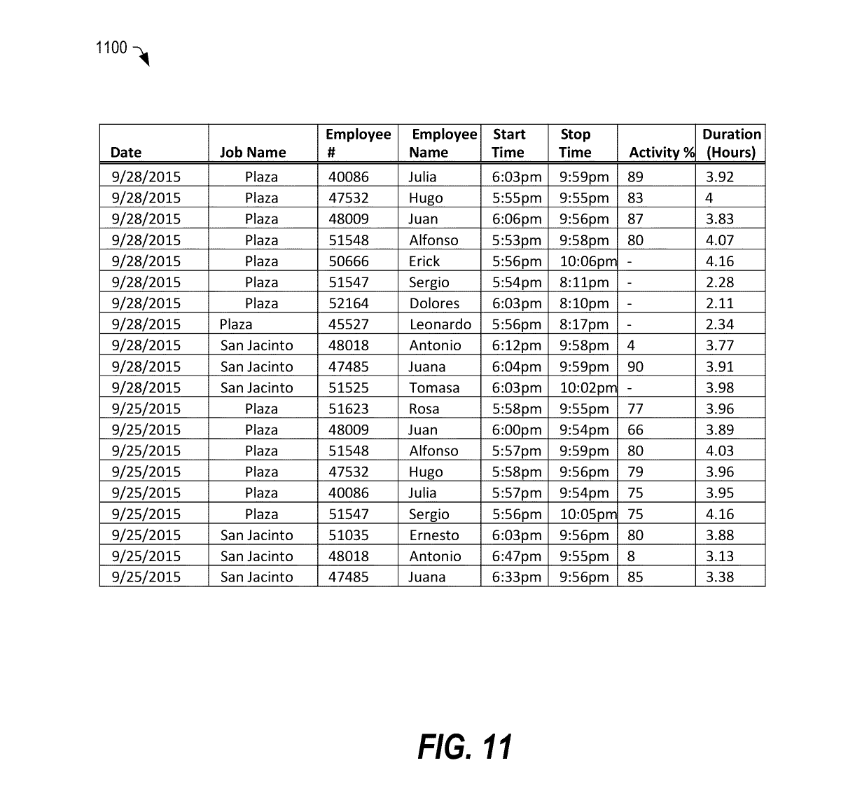

FIG. 11 depicts a diagram of a table 1100 showing employee activity intensity, in accordance with certain embodiments of the present disclosure. The table 1100 may include a date column, a job name or identifier, an employee number, an employee name, a start time, a stop time, a duration (in hours), and an activity percentage or activity intensity. In some embodiments, the activity percentage or activity intensity may include a total amount of time associated with actions or movements divided by a total number of hours. In the table 1100, a number of activity percentages are zeros. This may indicate a faulty device requiring replacement. Alternatively, the lack of motion data may indicate that the badge was set down or otherwise not worn during the shift. In some embodiments, the absence of motion data may indicate ghosting by another employee. Other embodiments are also possible.

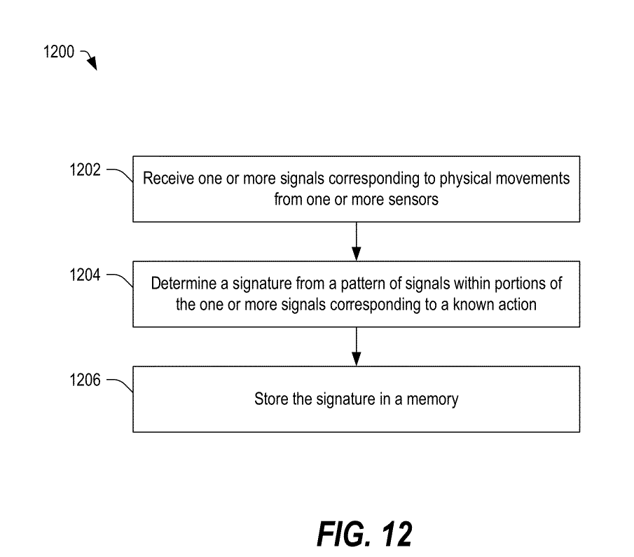

FIG. 12 depicts a flow diagram of a method 1200 of determining motion signature corresponding to a physical action (or set of actions) according to certain embodiments. At 1202, the method 1200 includes receiving one or more signals corresponding to physical movements from one or more sensors. The one or more signals may be received at a processing circuit, such as a processor configured to analyze data to identify signal patterns indicative of actions taken by a user. In some embodiments, the one or more signals may be received at an inertial measurement unit (IMU). In certain embodiments, the one or more signals may include signals corresponding to motion in an x-direction, a y-direction, a z-direction, or any combination thereof, from a magnetometer circuit, an accelerometer circuit, another motion detection circuit, or any combination thereof.

Continuing to 1204, the method 1200 may include determining a signature from a pattern of signals within portions of the one or more signals corresponding to a known action. The signature may include multiple data points over a period of time, such as a few seconds, which data points may be collected from multiple sensors of the same type or of different types. Further, the data may correspond to movements in various directions. The pattern of signals may correspond to a pattern that is repeated or substantially repeated each time a user performs a particular physical task, such as walking, mopping, etc. In certain embodiments, the patterns may be determined through a training process that may include providing pre-configured training sets to the system, calibrating the wearable element 108 to a particular user's movements, or any combination thereof. Once the pattern is determined, the method 1200 may include storing the signature in a memory, at 1206. The memory may be a non-volatile storage device.

In certain embodiments, each task or activity can have a unique signature comprised of a plurality of signal patterns corresponding to multiple movement axes. In certain embodiments, during a training process, a user may initiate a “task learning” operation using a smart phone, tablet, or other computing device or by pressing a button or interacting with an interface of the wearable element 108 or the base unit 106. After initiating the task learning operation, the user may perform a selected task while wearing the wearable element 108. The wearable element 108 may capture movement data corresponding to the performance of the task, and may provide the data to a computing device, which may correlate the data to the task-related signals to produce a task signature. The system may store the task signature. Subsequently, the system may compare received data to a plurality of task signatures in memory to identify portions of the data corresponding to a task signature. This correspondence may be used to determine a user's actions during a period of time, such as a work shift.

Further, in some embodiments, rather than motion data, the system may be configured to analyze audio data to determine actions performed by the employees. Other embodiments are also possible.

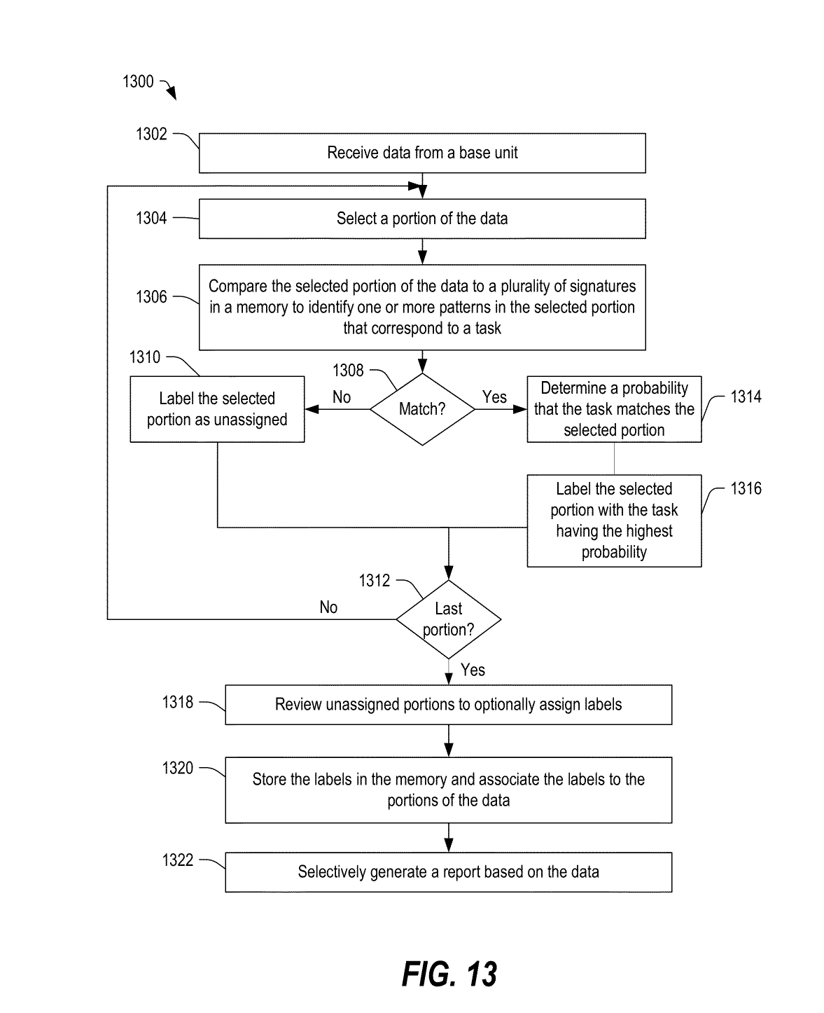

FIG. 13 depicts a flow diagram of a method 1300 of determining actions based on movement data and stored signatures according to certain embodiments. At 1302, the method 1300 may include receiving data from a base unit, such as base unit 106 in FIGS. 1 and 2. In certain embodiments, the data may be received at an employee management system, a management application, a smart phone, a tablet computer, another computing device, or any combination thereof. In certain embodiments, the data may be received at a circuit of the base unit 106 from a docking portion of the base unit 106, which docking portion may be coupled to one or more wearable elements 108 in order to receive the information.

Advancing to 1304, the method 1300 may include selecting a portion of the data. The portion may be a number of bits, a number of data points, a pre-determined time window, or some other portion of the data. Continuing to 1306, the method 1300 may include comparing the selected portion to a plurality of signatures (action or motion signatures) in a memory to identify one or more patterns within the selected portion that corresponds to a task.

Moving to 1308, if there is no pattern match within the selected portion, the method 1300 may label the selected portion as “unassigned”, at 1310. The method 1300 may determine if the portion is the last portion, at 1312. If not, the method 1300 returns to 1304 to select a next portion.

Returning to 1308, if the selected portion matches one or more of the signatures, the method 1300 may determine a probability that the task matches the selected portion, at 1314. Each user may move differently with respect to performance of a given task, and the motion signatures may have some commonalities and some differences, which may introduce errors in the match process.

Proceeding to 1316, the method 1300 may include labeling the selected portion with the task having the highest probability. In certain embodiments, a plurality of motion signals may correspond to multiple possible actions. However, by comparing the group of signals to the motion signatures, several possible candidates with differing degrees of probability may be determined, and the highest probability may be selected. In certain embodiments, the probabilities between two candidate tasks may be within a margin of error. In certain embodiments, the selected portion may be stored in a short term memory (such as within a cache memory device) and may be assigned the task based on the probabilities of actions immediately surrounding the task, making it possible to disambiguate similar actions based on surrounding motion activity. In an example, a task of emptying a trash can may be preceded and followed by walking activity, while vacuuming, mopping and other actions may have similar action-related signals that can differ slightly from the selected signals, but which may be similar and which can be used to disambiguate an unusual action sandwiched between actions that can be easily detected.

Moving to 1312, if the selected portion is not the last portion of the data, the method 1300 again returns to 1304 and a next portion of the data may be selected. Otherwise, the method 1300 may include reviewing unassigned portions of the data to optionally assign labels, at 1318. In certain embodiments, the unassigned portions of the data may be surrounded by labeled activities making it relatively easy to assign a label to such unassigned activities. For example, picking up a piece of trash within a sequence of actions that have been labeled mopping or vacuuming may present an unusual combination of signals, which the end user may assign to the category of mopping, in that particular instance, in order to classify the action in the larger context of the actions performed. Other labels are also possible.

Continuing to 1320, the method may include storing the labels in the memory and associating the labels with or to the portions of the data. The method 1300 may further include selectively generating a report based on the data. For example, extended periods of inactivity may cause the system to generate an alert, which may be sent via electronic message, printed message, audio signals, or another format. Other reports are also possible, such as a report indicating a particularly productive worker, a report indicating a difficult work issue, a report indicating poor form or potentially dangerous actions, etc.

In some embodiments, in addition to or in lieu of motion, audio data may be analyzed to determine particular activities. The tonality of the audio data may have a sound signature that corresponds to a particular action, such as lawn mowing, vacuuming, blowing leaves, and so on. Such sounds may be used to determine particular activities.

The methods, circuits, circuits, elements, and devices described above with respect to FIGS. 1-13 are illustrative only and are not intended to be limiting. Further, the processes, machines, and manufactures (and improvements thereof) described herein are particularly useful improvements for activity sensing devices and computers configured to determine actions from patterns of movements, sounds, or both. Any device, such as a smartphone or smart badge, could collect data and then allow (such as via an application programming interface “API”) the software and functions described herein to extract the data and perform calculations, comparisons, and analytics based on the collected data.

Further, the embodiments and examples herein provide improvements in the technology of motion detection and tracking systems. In addition, embodiments and examples herein provide improvements to the functioning of a computer by providing enhanced correlation of motion signals to pre-determined tasks, thereby creating a specific purpose computer by adding such technology. Thus, the improvements herein provide for technical advantages, such as providing a system in which a user's physical activity can be monitored and tracked for the purpose of determining employee efficiencies, for detecting a need for training of employees, for auditing and confirming time sheets, for detecting potentially hazardous activities, and for detecting or confirming potentially illegal activities (such as theft by maintenance personnel). For example, the system may detect extra travel to and from a location (or a period of time in which the wearable element 108 appears to be perfectly stationary), during which time other members of the team cannot confirm the employee's whereabouts. If something is reported stolen, such data may present a red flag to potentially identify the thief, for example.

In certain embodiments, the systems and processes described herein can be particularly useful to any system or service in which motion tracking may be of value, such as in fragile package tracking, exercise training, service industries, and so on. Further, the improvements herein provide additional technical advantages, such as providing a system in which actions can be detected and monitored and in which potentially dangerous or undesired actions can be detected. In certain embodiments, the system may send an alert to a manager or other user to alert the user to the potentially dangerous or undesired actions. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A system comprising:
a wearable element including:
a rechargeable battery;
at least one sensor circuit configured to capture at least one of movement data and sound data;
a transceiver configured to communicate the movement data; and
a base unit including a docking component configured to recharge the rechargeable battery and configured to communicate with the transceiver to receive at least one of the movement data, the sound data and an action determined from at least one of the movement data and the sound data.

2. The system of claim 1, wherein the wearable element further includes a radio frequency identifier (RFID) antenna configured to receive a first RF signal and to transmit a second RF signal including an identifier associated with the wearable element in response to the first RF signal.

3. The system of claim 2, wherein the wearable element comprises a programmable facility access card configured to allow access to one or more areas of a building.

4. The system of claim 1, further comprising a management system configured to receive at least one of the movement data and the sound data from the base unit.

5. The system of claim 4, wherein at least one of the base unit and the management system is configured to compare at least one of the movement data and the sound data to a plurality of action signatures corresponding to actions to identify one or more tasks.

6. The system of claim 1, wherein the wearable element comprises a badge.

7. The system of claim 1, wherein the at least one sensor circuit comprises at least one of a magnetometer, a gyroscope, an altimeter, and an accelerometer configured to generate signals in response to motion to produce the movement data.

8. The system of claim 1, wherein the wearable element further comprises:
at least one receiver configured to capture radio frequency signals from one or more transmitters; and
a memory device configured to store the movement data and data corresponding to the radio frequency signals.

9. The system of claim 8, wherein the transceiver communicates the movement data and the data corresponding to the radio frequency signals to the base unit.

10. A system comprising:
a wearable badge configured to record sensor data; and
a computing device configured to receive the sensor data, the computing device including:
a signal processing circuit configured to translate the sensor data into metrics;
an action classifier configured to transform the metrics to discrete movements; and
an activity estimator configured to determine one or more tasks based on the discrete movements.

11. The system of claim 10, wherein the computing device comprises a base unit including a recharger configured to recharge a battery of the wearable badge.

12. The system of claim 10, wherein the computing device comprises an employee management system.

13. The system of claim 10, wherein the metrics include at least one of bend angles, fundamental frequencies, motion statistics, and audio patterns.

14. The system of claim 10, wherein the wearable badge comprises:
one or more sensors configured to record data, the one or more sensors including at least one of an accelerometer, a magnetometer, an altimeter, and a gyroscope;
at least one radio frequency (RF) receiver configured to receive one or more RF signals from one or more transmitters;
an RF identifier (RFID) circuit configured to communicate with a card reader; and
an interface to communicate the movement data to the computing device.

15. The system of claim 10, further comprising at least one transceiver coupled to the activity estimator and configured to communicate data corresponding to the one or more tasks to a management system.

16. The system of claim 10, wherein the one or more tasks comprises at least one of walking, resting, mopping, vacuuming, emptying trash, and dusting.

17. The system of claim 10, further comprising a management system configured to receive data including the one or more tasks from the computing device, the management system including:
a productivity analysis module configured to analyze the one or more tasks relative to a period of time to determine productivity data; and
a reporting module configured to selectively transmit an alert related to an employee associated with the wearable badge when the productivity data falls below a first productivity threshold or exceeds a second productivity threshold.

18. A method comprising:
receiving motion data from one or more inertial measurement units of a wearable element at a computing device;
determining, using a signal processor of the computing device, metrics based on the motion data;
transforming the metrics into discrete movements using an action classifier of the computing device;
determining one or more tasks based on the discrete movements using an activity estimator of the computing device;
sending an alert to a destination device using at least one of a reporting module and a productivity analysis module of the computing device based on the one or more tasks.

19. The method of claim 18, further comprising:
receiving radio frequency (RF) signal data from the wearable element, the RF signal data including signal data captured by a sensor circuit of the wearable element that corresponds to RF signals from one or more RF transmitters; and
correlating the RF signal data to the one or more tasks to determine a location within a building where a particular task was performed.

20. The method of claim 18, wherein, before receiving the motion data, the method further comprises calibrating the wearable element to a particular user by instructing the user to perform a particular movement and by processing the movement data based on an expected action signature corresponding to the particular movement.
